(19) United States
(12) Patent Application Publication
(10) Pub. No.: US 2012/0300483 A1
(43) Pub. Date: Nov. 29, 2012

(54) Luminaire Assembly

(75) Inventors: Peter Helbig, Sontheim/Brenz (DE); Oliver Hering, Niederstotzingen (DE); Harald Kaps, Zusmarshausen (DE); Klaus Wittmann, Sontheim (DE)

(73) Assignee: OSRAM AG, Munich (DE)

(21) Appl. No.: 13/575,818

(22) PCT Filed: Jan. 17, 2011
(86) PCT No.: PCT/EP2011/050512

§ 371 Date: Jul. 27, 2012

(30) Foreign Application Priority Data
Jan. 27, 2010 (DE) 102010001255.6

(51) Int. Cl. B60Q 1/04

(52) U.S. Cl. 362/508; 362/543

(57) ABSTRACT

A luminaire assembly, in particular a bi-halogen headlight for a motor vehicle, having at least one light source, which has at least two lighting functions, characterized in that the light source has a different operating voltage in each case with regard to the at least two lighting functions.

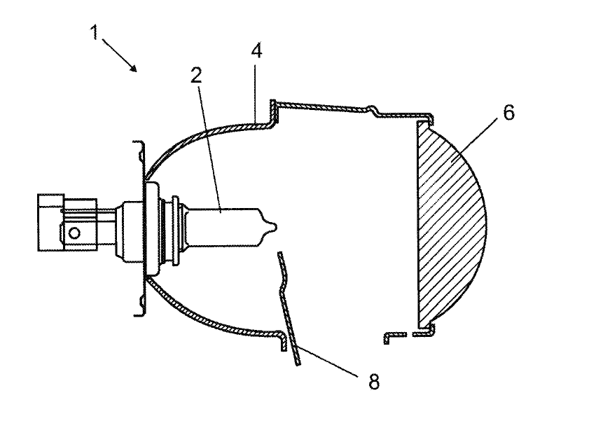

### AREA OF TECHNOLOGY

The invention is based on a luminaire assembly in accordance with the preamble of claim 1.

### PRIOR ART

Document DE 10 2006 057 748 A1 discloses such a luminaire assembly which is employed for a motor vehicle headlight. Here this is a bi-halogen headlight by means of which a dipped beam and a main beam are produced from a single light source. When the main beam of a motor vehicle is actuated, a baffle is moved by means of a magnetic force out of a beam path of the light source in order to release a greater area of the beam path. Conversely, on switching from the main beam to the dipped beam, the baffle is moved into the beam path. On switching between main beam and dipped beam, the light color and light intensity remain essentially unchanged. An H7 or H9 halogen lamp for example is employed as the light source for such a bi-halogen headlight. Alternatively, a xenon lamp can be used as the light source.

On dipped beam, such motor vehicle headlights exhibit a considerably greater shading effect than conventional motor vehicle headlights, for which reason the halogen lamp requires a higher luminous flux in order for example to meet necessary legal provisions for the light distribution of the motor vehicle headlight. The higher luminous flux can for example be achieved by means of a more powerful halogen lamp, which is however more complex technically in terms of its device design in comparison with a less powerful halogen lamp and requires more energy. Alternatively, it is also possible to employ a conventional halogen lamp with an increased output, which disadvantageously results in a reduced service life.

### STATEMENT OF THE INVENTION

The object of the present invention is to create a luminaire assembly, in particular a bi-halogen headlight, for a motor vehicle, having a long service life and a low technical complexity in terms of its device design.

This object is achieved by a luminaire assembly according to the features of claim 1.

According to the invention, a luminaire assembly for a headlight of a motor vehicle has at least one light source. The luminaire assembly in question is for example a bi-halogen or bi-xenon headlight. The light source has at least two lighting functions and has a different operating voltage in each case with regard to the respective lighting function.

It has been shown in tests that the service life of the luminaire assembly can be significantly increased hereby with a low level of technical complexity in terms of device design. In addition, an energy saving is achieved at a lower operating voltage.

Particularly advantageous embodiments are set down in the dependent claims.

By preference, the one lighting function of the light source in the case of headlights for motor vehicles is a normal dipped beam and the other is a main beam.

By preference, a movable baffle is provided which can be moved in or out for switching between the dipped beam and the main beam from a light path generated by the light source.

In a further embodiment of the invention, at least one of the lighting functions takes place at an operating voltage of the light source increased or reduced by between greater than 0 to 15% compared with a standard operating voltage.

A considerable service life extension of the luminaire assembly is made possible if at least one of the lighting functions takes place at an operating voltage of the light source reduced by about 5 to 10% compared with the standard operating voltage. An increase in the operating voltage for at least one lighting function by 5 to 10% compared with the standard operating voltage makes possible an improved light performance as a result of the increase in the light emission.

The luminaire assembly can be an adaptive frontlighting system (AFS).

In a further embodiment of the invention, the luminaire assembly has a plurality of light sources each having one or more lighting functions. In order to extend the service life, at least one light source is provided wherein the lighting functions are implemented by different operating voltages of the light source.

A standard operating voltage of the luminaire assembly can be 13.2 volt, whereby the operating voltage for the dipped beam is then about 13.6 volt and for the main beam about 11.9 volt or about 12.2 volt.

A long service life extension also results in the case of an operating voltage for the dipped beam of about 12.2 volt and for the main beam of about 13.6 volt, at a conventional standard operating voltage of 13.2 volt.

The aforementioned values for standard operating voltage, operating voltage of dipped beam and main beam are advantageous for a luminaire assembly which is operated at a vehicle electrical system voltage of nominally 12 volt, such as for example in a car. For a luminaire assembly which is being operated at a vehicle electrical system voltage of nominally 24 volt, such as is usual for example in trucks, the standard operating voltage can be 28 volt. In this case the operating voltage of the light source is also reduced or increased for at least one of the lighting functions by a value in the range from greater than 0 percent to less than or equal to 15 percent, and preferably in the range from greater than 5 percent to less than or equal to 10 percent, compared with the standard operating voltage.

### BRIEF DESCRIPTION OF THE DRAWING

The invention will be described in detail in the following with reference to an exemplary embodiment. The single FIGURE shows a schematic illustration of a luminaire assembly.

### PREFERRED EMBODIMENT OF THE INVENTION

The single FIGURE shows a greatly simplified schematic illustration of a luminaire assembly 1 in accordance with an exemplary embodiment. Here this is a bi-halogen headlight for a motor vehicle. Such headlights produce a dipped beam and a main beam from a single light source. The light source illustrated in this FIGURE is an H7 tungsten halogen bulb, which is referred to in the following as lamp 2. The H7 tungsten halogen bulb has only one filament which serves as the light source for producing the main beam and also the dipped beam.

The luminaire assembly 1 has a reflector 4 encompassing the lamp 2 and a projection lens 6 lying in a beam path.

It is possible to switch between the dipped beam and main beam lighting functions by means of a baffle 8 arranged between the projection lens 6 and the lamp 2. The dipped beam and main beam lighting functions thus differ in that a cross-section of the beam path is greater for the main beam than for the dipped beam. The baffle 8, which can be moved into and out of the beam path for example by means of a magnetic force of an electromagnet, is used to change the cross-section of the beam path. When the cross-section of the beam path is changed, the light color and light intensity of the radiation remain largely unchanged.

With regard to the luminaire assembly 1 shown in the FIGURE, shading effects of the dipped beam are greater than in the case of conventional motor vehicle headlights which have one light source each for dipped beam and main beam. By increasing the operating voltage compared with the standard operating voltage of the lamp 2, which for example is 13.2 volt, when the latter is employed with the dipped beam lighting function, the light emission is increased. This means that it is possible for the luminaire assembly 1 to achieve or approximately achieve the lighting properties of the conventional motor vehicle headlight on dipped beam in spite of an increased shading effect. It is possible to compensate for a reduced service life resulting therefrom through a suitable choice of an operating voltage for the main beam lighting function.

It has been shown in tests that the service life of the luminaire assembly 1 can even be increased if the latter is employed with an operating voltage increased for one lighting function and reduced for another lighting function in comparison with the standard operating voltage.

For this purpose, several advantageous configurations for the different operating voltages of the lighting functions are represented in the following, whereby the standard operating voltage of the lamp 2 is 13.2 volt. A switching share shown in the tables below represents the ratio of the operating time of the lighting functions.

a)

| | Voltage | Luminous flux | Switching share |
|---|---|---|---|
| Main beam | 11.9 volt | −30% | 1 |
| Dipped beam | 13.6 volt | 11% | 2 |

The main beam is thus employed at a reduced operating voltage for about 33% of the operating time of the lamp 2, whereas the dipped beam is employed at an increased operating voltage for about 66% of the operating time. This configuration results in an extension of the overall service life of about 50% compared with a conventional use of the lamp 2 at 13.2 volt standard operating voltage.

b)

| | Voltage | Luminous flux | Switching share |
|---|---|---|---|
| Main beam | 11.9 volt | −30% | 1 |
| Dipped beam | 13.6 volt | 11% | 5 |

In contrast to the configuration under a), here the switching share of the dipped beam is considerably increased and is about 83%. This configuration does nevertheless result in an extension of the overall service life of about 12% compared with a conventional use of the lamp 2 at 13.2 volt standard operating voltage.

c)

| | Voltage | Luminous flux | Switching share |
|---|---|---|---|
| Main beam | 12.2 volt | −24% | 1 |
| Dipped beam | 13.6 volt | 11% | 2 |

The main beam is used with an increased voltage compared with a) and b), as a result of which the luminous flux rises. The overall service life of the lamp 2 in this case is about 27% compared with a conventional use of the lamp 2 at 13.2 volt standard operating voltage.

d)

| | Voltage | Luminous flux | Switching share |
|---|---|---|---|
| Main beam | 12.2 volt | −24% | 1 |
| Dipped beam | 13.6 volt | 11% | 5 |

In this configuration the switching share of the dipped beam is increased compared with c). The overall service life corresponds to that in the case of a conventional use of the lamp 2 at 13.2 volt standard operating voltage.

If the luminous flux of the lamp 2 with the dipped beam lighting function is sufficient at a conventional standard operating voltage, then it is conceivable to retain or even to reduce the operating voltage of the lamp 2 with the dipped beam lighting function and to increase the operating voltage with the main beam lighting function for a greater range. For this purpose, several advantageous configurations for the different operating voltages of the lighting functions are represented in the following, whereby the standard operating voltage of the lamp 2 is 13.2 volt.

e)

| | Voltage | Luminous flux | Switching share |
|---|---|---|---|
| Main beam | 13.6 volt | 11% | 1 |
| Dipped beam | 12.2 volt | −24% | 2 |

The overall service life of the lamp 2 in this configuration of the operating voltages is increased by about 80%.

f)

| | Voltage | Luminous flux | Switching share |
|---|---|---|---|
| Main beam | 13.6 volt | 11% | 1 |
| Dipped beam | 12.2 volt | −24% | 5 |

In this configuration the overall service life is increased by 110%.

The luminaire assembly 1 is not restricted to the dipped beam and main beam lighting functions but can be employed in any desired complexity for example in an adaptive frontlighting system (AFS) and can be applied to each individual lighting function and the luminous flux requirement thereof.

Disclosed is a luminaire assembly, in particular a bi-halogen headlight for a motor vehicle. Said headlight has a light source having at least two lighting functions. The operating voltages of the light source for an associated lighting function differ relative to one another.

1. A luminaire assembly having at least one light source, which has at least two lighting functions, wherein the light source has a different operating voltage in each case with regard to the at least two lighting functions.

2. The luminaire assembly as claimed in claim 1, wherein the luminaire assembly is a bi-halogen headlight for a motor vehicle, and the light source has precisely two lighting functions, wherein one lighting function is a dipped beam and the other is a main beam.

3. The luminaire assembly as claimed in claim 2, wherein a movable baffle is provided which can be moved in or out for switching dipped beam and main beam from a light path generated by the light source.

4. The luminaire assembly as claimed in claim 1, wherein at least one of the lighting functions takes place at an operating voltage of the light source increased or reduced by about between greater than 0 to 15% compared with a standard operating voltage.

5. The luminaire assembly as claimed in claim 1, wherein at least one of the lighting functions takes place at an operating voltage of the light source increased or reduced by about 5 to 10% compared with the standard operating voltage.

6. The luminaire assembly as claimed in claim 1, wherein the luminaire assembly is a bi-halogen headlight for a motor vehicle, and wherein the luminaire is an adaptive frontlighting system (AFS).

7. The luminaire assembly as claimed in claim 1, comprising a plurality of light sources each having one or more lighting functions, wherein for at least one light source the lighting functions are implemented by different operating voltages of the light source.

8. The luminaire assembly as claimed in claim 4, wherein the standard operating voltage is about 13.2 volt, the operating voltage for the dipped beam is about 13.6 volt and for the main beam about 11.9 volt or about 12.2 volt.

9. The luminaire assembly as claimed in claim 4, wherein the standard operating voltage is about 13.2 volt, the operating voltage for the dipped beam is about 12.2 volt and for the main beam about 13.6 volt.
